(19) United States
(12) Patent Application Publication
(10) Pub. No.: US 2017/0294871 A1
(43) Pub. Date: Oct. 12, 2017

(54) SOLAR POWER GENERATION SYSTEM

(71) Applicant: Dongyoul SHIN, Gangwon-do (KR)

(72) Inventor: Dongyoul SHIN, Gangwon-do (KR)

(21) Appl. No.: 15/384,151

(22) Filed: Dec. 19, 2016

(30) Foreign Application Priority Data
Apr. 12, 2016 (KR) 10-2016-0045105

(51) Int. Cl. H02S 20/32; F16H 25/20; F15B 15/14; H02S 50/00; H02S 30/20

(52) U.S. Cl. CPC H02S 20/32; H02S 50/00; H02S 30/20; F15B 15/14; F16H 25/20; F16H 2025/2043; F16H 2025/2081

(57) ABSTRACT

There is provided a solar power generation system comprising: a main body being hollow and having an inner space defined therein, wherein the main body has a top hole defined in a top wall thereof; a rotation assembly received in the main body; a hydraulic or pneumatic cylinder assembly received in the main body; a power generation assembly configured to be withdrawn from the main body or retracted into the main body through the top hole using the hydraulic or pneumatic cylinder assembly, wherein the power generation assembly has a solar cell structure at a top end thereof, wherein the rotation assembly is configured to change an orientation of the solar cell structure; a controller configured to control operations of the rotation assembly and the hydraulic or pneumatic cylinder assembly.

### CROSS-REFERENCE TO RELATED APPLICATION

This application claims the benefit of Korea patent application No. 10-2016-0045105 filed on Apr. 12, 2016, the entire content of which is incorporated herein by reference for all purposes as if fully set forth herein.

### BACKGROUND

### Field of the Present Disclosure

The present disclosure relates to a solar power generation system, and, more particularly, to a solar power generation system wherein an orientation of a solar cell plate is adapted to a movement of the sun, and the solar cell plate is withdrawn from or retracted into a housing based on environmental conditions.

### Discussion of Related Art

Generally, photovoltaic power generation is to convert solar energy into electric energy, which consists of a solar panel, a battery, and a power inverter (micro inverter). In other words, when sunlight is incident onto a solar panel that is a junction of a p-type semiconductor and an n-type semiconductor, holes and electrons are generated in the solar cell by the energy of the sunlight. At this time, the holes are collected toward the p-type semiconductor and the electrons are collected toward the n-type semiconductor. When the potential difference is generated, electricity is produced. The electricity thus generated is stored in the battery and stored electricity is converted into AC current through the micro inverter.

The advantage of such solar power generation is that there is no pollution, it can be developed as needed only in the place where it is needed, and it is easy to maintain the same. Thus, recently, it is applied as alternative energy in various places and fields such as home. However, due to the fixed installation thereof, it is always exposed to natural disasters in a defenseless manner, so that breakdown frequently occurs and the life thereof is not long. In addition, due to the nature of the fixed installation, there is limitations to receive the solar beam.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide a solar power generation system, wherein an orientation of a solar cell plate is adapted to a movement of the sun, and the solar cell plate is withdrawn from or retracted into a housing based on environmental conditions, and the solar cell plate is folded or unfolded based on the environmental conditions, and the solar power generation system is entirely movable, and the switching between the automatic and manual modes are available.

In one aspect of the present disclosure, there is provided a solar power generation system comprising: a main body being hollow and having an inner space defined therein, wherein the main body has a top hole defined in a top wall thereof; a rotation assembly received in the main body; a hydraulic or pneumatic cylinder assembly received in the main body; a power generation assembly configured to be withdrawn from the main body or retracted into the main body through the top hole using the hydraulic or pneumatic cylinder assembly, wherein the power generation assembly has a solar cell structure at a top end thereof, wherein the rotation assembly is configured to change an orientation of the solar cell structure; a controller configured to control operations of the rotation assembly and the hydraulic or pneumatic cylinder assembly.

In one implementation, the rotation assembly includes a horizontal-oriented driving gear; a step motor operably coupled to the horizontal-oriented driving gear, wherein the step motor is configured to rotate in a forward and reverse direction; and a horizontal-oriented driven gear meshed with the horizontal-oriented driving gear, wherein the horizontal-oriented driven gear is coupled via a shaft to the solar cell structure, wherein the shaft vertically extend from the horizontal-oriented driven gear through the hydraulic or pneumatic cylinder assembly to the solar cell structure.

In one implementation, the horizontal-oriented driven gear vertically overlaps the top hole.

In one implementation, the hydraulic or pneumatic cylinder assembly includes a cylinder body and a vertical translation rod configured to be withdrawn out of or retracted into the cylinder body, wherein the cylinder body has a hydraulic or pneumatic piston vertically moveable therein, wherein the vertical translation rod is fixed to the piston at a top end thereof, wherein the vertical translation rod is coupled to the power generation assembly.

In one implementation, the power generation assembly includes: a folding motor coupled to the hydraulic or pneumatic cylinder assembly wherein the folding motor operates in a forward and reverse direction.

In one implementation, the power generation assembly includes: a threaded vertical rod having a thread defined in an outer face thereof, wherein the threaded vertical rod is operably coupled to the folding motor, wherein the threaded vertical rod passes through the top hole defined in the main body.

In one implementation, the power generation assembly includes a support plate fixed to a top end of the folding motor.

In one implementation, the power generation assembly includes a hub coupled to the threaded vertical rod at the top end thereof via a bearing such that the rotation of the threaded vertical rod is independent from the rotation of the hub.

In one implementation, the power generation assembly include a hollow nut block having an inner thread defined in the inner face thereof such that the hollow nut block is engaged with the threaded vertical rod, wherein when the threaded vertical rod rotates, the hollow nut block ascends or descends along the threaded vertical rod along the thread line.

In one implementation, the power generation assembly includes a vertical translation guide to guide a vertical translation of the hollow nut block, wherein the vertical translation guide extends vertically from a support plate through the hollow nut block to the hub, wherein the support plate is fixed to a top end of the folding motor.

In one implementation, the solar cell structure includes two solar cell plates radially extending from the hub in a symmetrical manner, wherein each solar cell plate has a tilted face, wherein the tilted faces of the two solar cell plates have the same tilt orientation, wherein each of the two solar cell plates is hinged-coupled to the hub.

In one implementation, the power generation assembly includes two links to allow an operable connection between the hollow nut block and solar cell plates respectively, wherein each of the links has a lower end hinged-coupled to the hollow nut block via a hinge and an upper end hinged-coupled to the solar cell plate via a hinge.

In one implementation, the system further comprises a sun tracking unit configured to measure a sunshine amount depending on a movement of the sun, wherein the sun tracking unit determines an orbital position of the sun based on the variation in the sunshine amount, wherein the sun tracking unit is connected to the controller wirelessly or in a wired manner to send the position of the sun to the controller.

In one implementation, the controller is configured to control the operation of the rotation assembly based on the position of the sun.

In one implementation, the system further comprises a wind speed sensor, a shock sensor and/or a pressure sensor for sensing a speed of a wind out of the main body, a shock and/or a pressure applied to the main body respectively, the wind speed sensor, the shock sensor and/or the pressure sensor are connected to the controller wirelessly or in a wired manner to send the wind speed, the shock and/or pressure to the controller respectively, wherein the controller is configured to operation of the hydraulic or pneumatic cylinder assembly based on the wind speed, the shock and/or pressure.

In one implementation, the system further comprises a wind speed sensor, a shock sensor and/or a pressure sensor for sensing a speed of a wind out of the main body, a shock and/or a pressure applied to the main body respectively, the wind speed sensor, the shock sensor and/or the pressure sensor are connected to the controller wirelessly or in a wired manner to send the wind speed, the shock and/or pressure to the controller respectively, wherein the controller is configured to operation of the folding motor based on the wind speed, the shock and/or pressure.

In one implementation, the controller has a data storage to store a predetermined pressure, shock and/or wind speed, wherein the controller is configured to control the operation of the hydraulic or pneumatic cylinder assembly such that when the wind speed, the shock and/or pressure from the sensors exceed the predetermined pressure, shock and/or wind speed, the power generation assembly is retracted into the main body.

In one implementation, the controller has a data storage to store a predetermined pressure, shock and/or wind speed, wherein the controller is configured to control the operation of the folding motor such that when the wind speed, the shock and/or pressure from the sensors exceed the predetermined pressure, shock and/or wind speed, the solar cell plates are folded.

In one implementation, the controller has a mode switching module to allow the solar power generation system to operate in between an automatic mode and manual mode.

In one implementation, the controller includes a wireless communication module to allow the controller to communicate with a separate wireless controller wirelessly, wherein the wireless controller controls switching between an automatic mode and manual mode of the system.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a perspective view of a solar power generation system in accordance with the present disclosure.

FIG. 2 is a side elevation view of a solar power generation system in accordance with the present disclosure.

FIG. 3 is a perspective view of a power generation assembly of a solar power generation system in accordance with the present disclosure.

FIG. 4 is a block diagram of a sun tracking unit, a controller, and a sensor set of a solar power generation system in accordance with one embodiment of the present disclosure.

FIG. 5 is a block diagram of a sun tracking unit, a controller, and a sensor set of a solar power generation system in accordance with another embodiment of the present disclosure.

FIG. 6 is a perspective view of a state when a power generation assembly of a solar power generation system in accordance with the present disclosure is ascended and unfolded.

FIG. 7 is a top view for describing a movement of solar cell plates depending on a sun position for a solar power generation system in accordance with the present disclosure.

FIG. 8 is a side elevation view for describing fold and unfold operations of solar cell plates for a solar power generation system in accordance with the present disclosure.

FIG. 9 is a side elevation view for describing a descending operation of a power generation assembly of a solar power generation system in accordance with the present disclosure.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises” ′, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

Further, the use of “may” when describing embodiments of the present disclosure refers to “one or more embodiments of the present disclosure.”

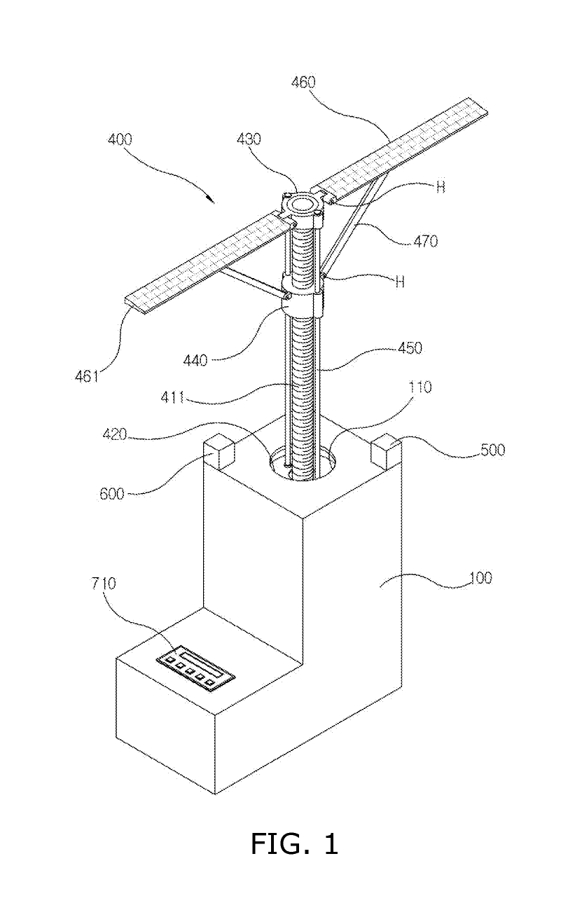

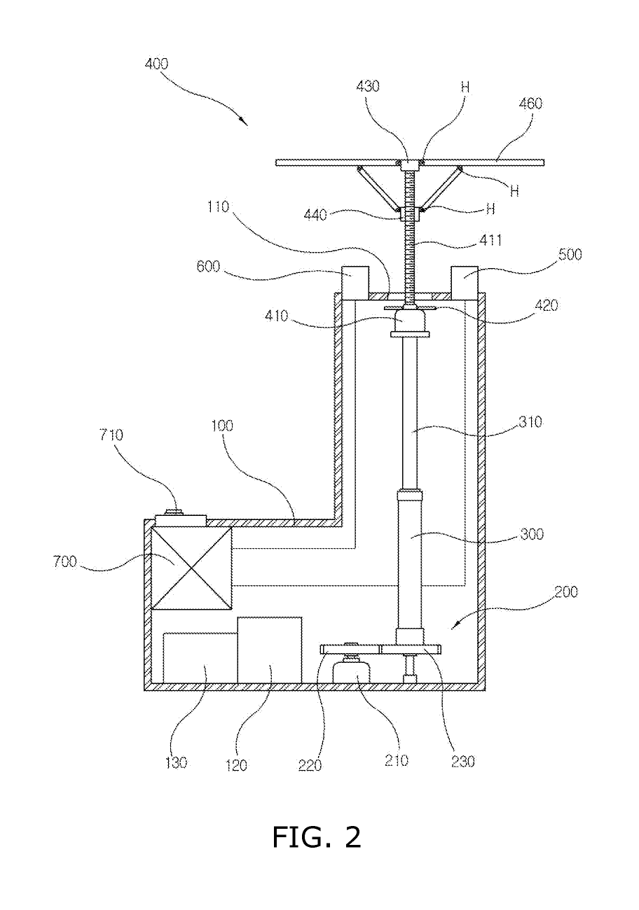

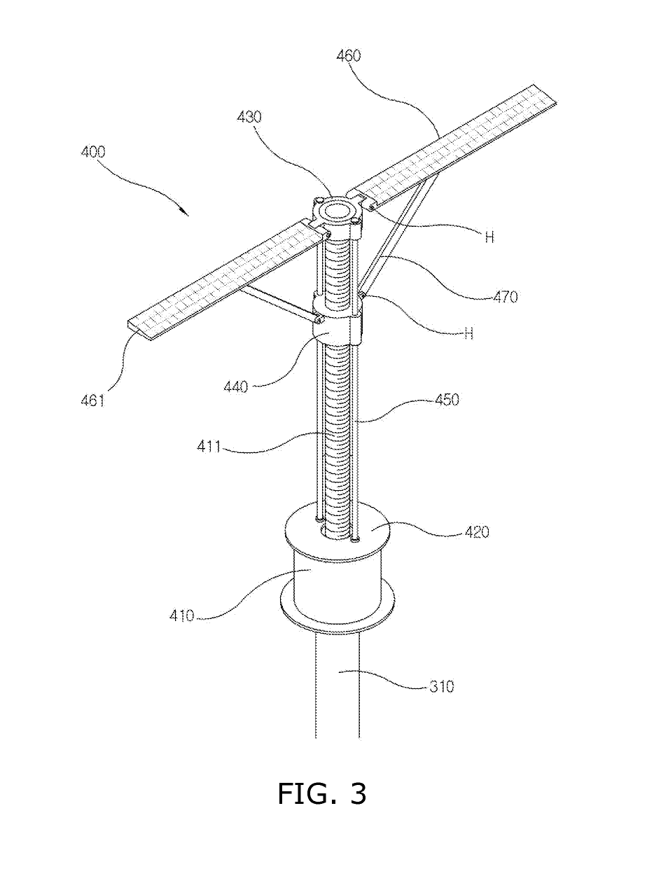

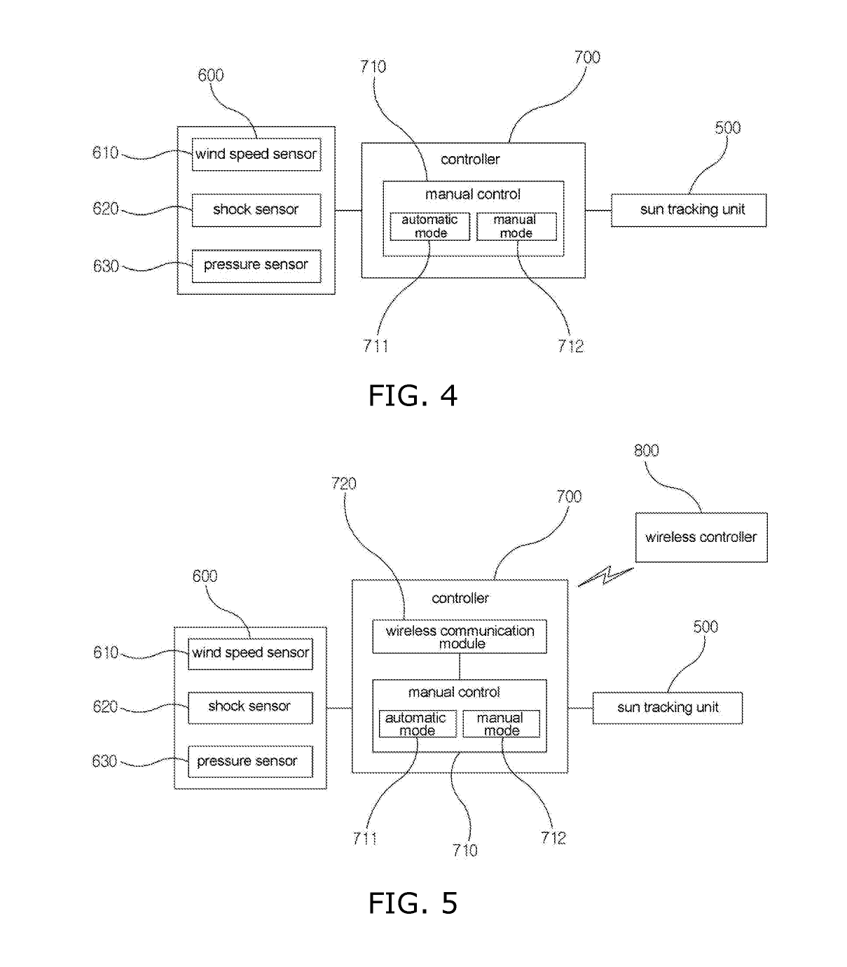

FIG. 1 is a perspective view of a solar power generation system in accordance with the present disclosure. FIG. 2 is a side elevation view of a solar power generation system in accordance with the present disclosure. FIG. 3 is a perspective view of a power generation assembly of a solar power generation system in accordance with the present disclosure. FIG. 4 is a block diagram of a sun tracking unit, a controller, and a sensor set of a solar power generation system in accordance with one embodiment of the present disclosure.

Referring to FIG. 1 to FIG. 4, a solar power generation system in accordance with the present disclosure may include a main body 100, a rotation assembly 200, a hydraulic or pneumatic cylinder assembly 300, a power generation assembly 400, a sun tracking unit 500, a sensor set 600, and a controller 700.

In this connection, the main body 100 may be hollow and have an inner space to accommodate various components of the solar power generation system. In one example, the main body 100 may have a L shape having horizontal and vertical portions.

In this connection, the main body 100 may have a top hole 110 defined in a top wall thereof. The main body 100 may accommodate therein a storage battery 120 to store electrical energy generated from the solar power generation system, and a micro-inverter 130 to convert a DC electrical energy to an AC electrical energy.

The rotation assembly 200 may be received in the main body 100 and may be configured to rotate the power generation assembly 400.

In this connection, the rotation assembly 200 may include a horizontal-oriented driving gear 220 disposed in a bottom portion of the main body 100; a step motor 210 operably coupled to the horizontal-oriented driving gear 220 and disposed beneath the horizontal-oriented driving gear 220, wherein the step motor 210 may be configured to rotate in a forward and reverse direction; and a horizontal-oriented driven gear 230 meshed with the horizontal-oriented driving gear 220, wherein the horizontal-oriented driven gear 230 may be coupled via a shaft to the body to rotate freely, wherein the horizontal-oriented driven gear 230 may vertically overlap the top hole 110.

The hydraulic or pneumatic cylinder assembly 300 may be coupled to the rotation assembly 200. A vertical translation rod 310 of the hydraulic or pneumatic cylinder assembly 300 may ascend or descend using the hydraulic or pneumatic force. In this connection, the hydraulic or pneumatic cylinder assembly 300 may include a cylinder body and the vertical translation rod 310 configured to be withdrawn out of or retracted into the cylinder body, wherein the cylinder body may be embodied as a hydraulic or pneumatic cylinder. The cylinder body may have a hydraulic or pneumatic piston vertically moveable therein.

The power generation assembly 400 may be configured such that the vertical translation of the vertical translation rod of the hydraulic or pneumatic cylinder assembly 300 may allow the ascending or descending operation of the power generation assembly 400 through the top hole 110 defined in the main body 100.

In this connection, power generation assembly 400 as shown in FIG. 3 may include a folding motor 410 fixed to a top end of the vertical translation rod 310 of the hydraulic or pneumatic cylinder assembly 300 wherein the folding motor 410 may operate in a forward and reverse direction; and a threaded vertical rod 411 having a thread defined in an outer face thereof, wherein the threaded vertical rod 411 may be operably coupled to the folding motor 410, wherein the threaded vertical rod 411 may pass through the top hole 110 defined in the main body 100. In one embodiment, the hydraulic or pneumatic cylinder assembly 300 may have a hydraulic piston to vertically move the large solar cell plate.

Moreover, the power generation assembly 400 may include a support plate 420 fixed to a top end of the folding motor 410. In this connection, the support plate 420 may not interfere with the rotation of the threaded vertical rod 411.

Moreover, the power generation assembly 400 may include a hub 430 coupled to the threaded vertical rod 411 at the top end thereof via a bearing (not shown) such that the rotation of the threaded vertical rod 411 is independent from the rotation of the hub 430.

Moreover, the power generation assembly 400 may include a hollow nut block 440 having an inner thread defined in the inner face thereof such that the hollow nut block 440 may be engaged with the threaded vertical rod 411. When the threaded vertical rod 411 rotates, the hollow nut block 440 may ascend or descend along the threaded vertical rod 411 along the thread line.

Moreover, the power generation assembly 400 may include a vertical translation guide 450 to guide a vertical translation of the the hollow nut block 440. In this connection, the vertical translation guide 450 may be at least two. Each of the vertical translation guides 450 may extend vertically from the support plate 420 through the hollow nut block 440 to the hub 430. The hollow nut block 440 may slide along the vertical translation guide 450.

That is, the hollow nut block 440 may vertically move along the threaded vertical rod 411 upon the rotation of the folding motor 410. In this connection, the vertical translation guide 450 may guide the movement of the hollow nut block 440. The vertical translation guide 450 may prevent a rotation of the hollow nut block 440 driven by the rotation of the threaded vertical rod 411.

Moreover, the power generation assembly 400 may include two solar cell plates 460 radially extending from the hub 430 in a symmetrical manner. In this connection, each solar cell plate 460 may have a tilted face 461, wherein the tilted faces of the two solar cell plates 460 may have the same tilt orientation. Each of the two solar cell plates 460 may be hinged-coupled to the hub 430 via a hinge H.

Moreover, the power generation assembly 400 may include two links 470 to allow an operable connection between the hollow nut block 440 and solar cell plates 460 respectively. In this connection, each of the links 470 may have a lower end hinged-coupled to the hollow nut block 440 via a hinge H and an upper end hinged-coupled to the solar cell plate 460 via a hinge H.

That is, the power generation assembly 400 may rotate via the horizontal-oriented driven gear 230 by the operation of the rotation assembly 200. The rod 310 of the hydraulic or pneumatic cylinder assembly 300 may be withdrawn from or retracted into the main body 100 via the top hole 110. The operation of the folding motor 410 may allow the folding and unfolding operations of the solar cell plates 460 via the links 470 during the hollow nut block 440 slides vertically along the threaded vertical rod 411.

The sun tracking unit 500 may measure a sunshine amount depending on a movement of the sun. The sun tracking unit 500 may determine the orbital position of the sun based on the variation in the sunshine amount. The sun tracking unit 500 may be disposed out of the main body 100. In this connection, the sun tracking unit 500 may be conventional. That is, the sun tracking unit 500 may be limited particularly as long as the sun tracking unit 500 measures a variation of the sunshine amount. In one embodiment, the sun tracking unit 500 may be connected to the controller 700 wirelessly or in a wired manner to send the variation of the sunshine amount to the controller.

The sensor set 600 may be disposed out of the main body 100. The sensor set 600 may include a wind speed sensor 610 for sensing a speed of a wind out of the main body 100, a shock sensor 620 for sensing a shock applied to the main body 100, and a pressure sensor 630 for sensing a pressure applied to the main body 100. The wind speed sensor 610 may be limited particularly as long as the wind speed sensor 610 senses the speed of the wind. In one embodiment, the wind speed sensor 610 may be connected to the controller 700 wirelessly or in a wired manner to send the wind speed to the controller.

The shock sensor 620 may be limited particularly as long as the shock sensor 620 senses the shock. In one embodiment, the shock sensor 610 may be connected to the controller 700 wirelessly or in a wired manner to send the shock level to the controller. The pressure sensor 630 may be limited particularly as long as the pressure sensor 630 senses the pressure. In one embodiment, the pressure sensor 630 may be connected to the controller 700 wirelessly or in a wired manner to send the pressure level to the controller.

The controller 700 may be disposed in the main body 100 and may be configured to control operations of the rotation assembly 200, hydraulic or pneumatic cylinder assembly 300 and folding motor 410 based on the received pressure, shock, variation in the sunshine, and/or the wind speed.

That is, the controller 700 may be configured to control the operation of the step motor 210 of the rotation assembly 200 based on the variation in the sunshine measured by the sun tracking unit 500. Thus, the orientation of the solar cell plates 460 may be adjusted.

Further, the controller 700 may have a data storage to store a predetermined pressure, shock and/or wind speed. The controller 700 may be configured to control the operations of the folding motor 410 and hydraulic or pneumatic cylinder assembly 300 based on comparisons between the measurements from the sensor set 600 and the predetermined pressure, shock and/or wind speed. For example, when the measurements from the sensor set 600 exceed the predetermined pressure, shock and/or wind speed, the solar cell plate 460 may be folded and the power generation assembly 400 may be retracted into the main body 100.

In one embodiment, the controller 700 may include a manual control 710 to allow an operator to manually control the solar power generation system. The manual control 710 may be disposed out of the main body. For example, using the manual control 710, the operator may power on/off the solar power generation system. In one example, using the manual control 710, the operator may manually control the operations of the rotation assembly 200, the hydraulic or pneumatic cylinder assembly 300, and the folding motor 410.

In one embodiment, the manual control 710 may have a mode switching module to allow the solar power generation system to operate in between an automatic mode 711 and manual mode 712.

In one embodiment, as shown in FIG. 5, the controller 700 may include a wireless communication module 720 to allow the controller 700 to communicate with a separate wireless controller 800 wirelessly. In one example, the wireless controller 800 may control the switching between automatic mode 711 and manual mode 712 of the controller 700.

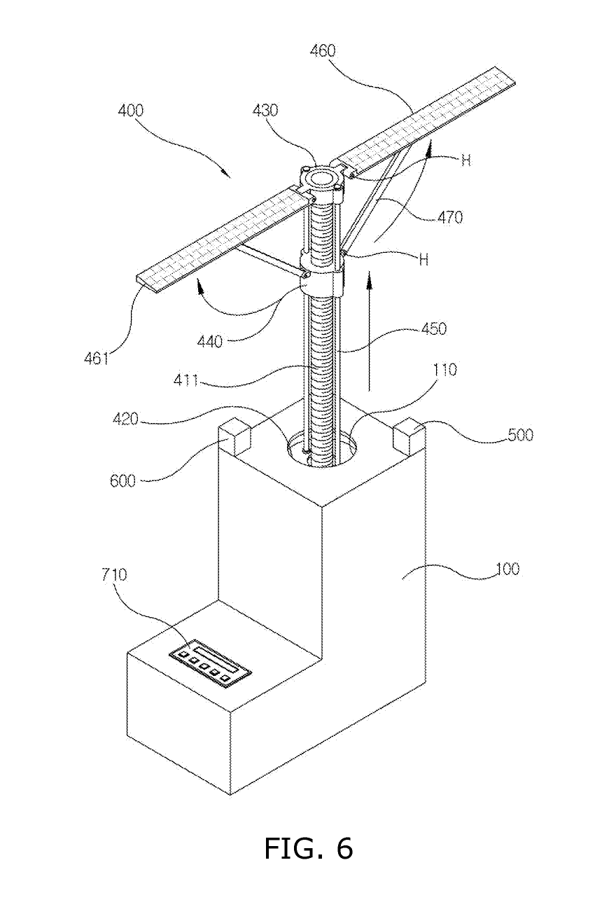

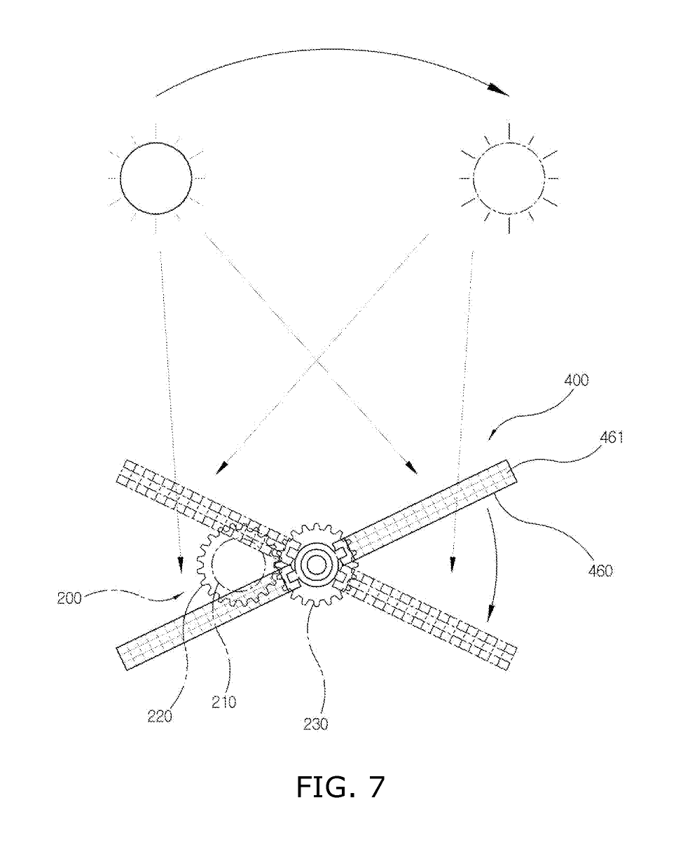

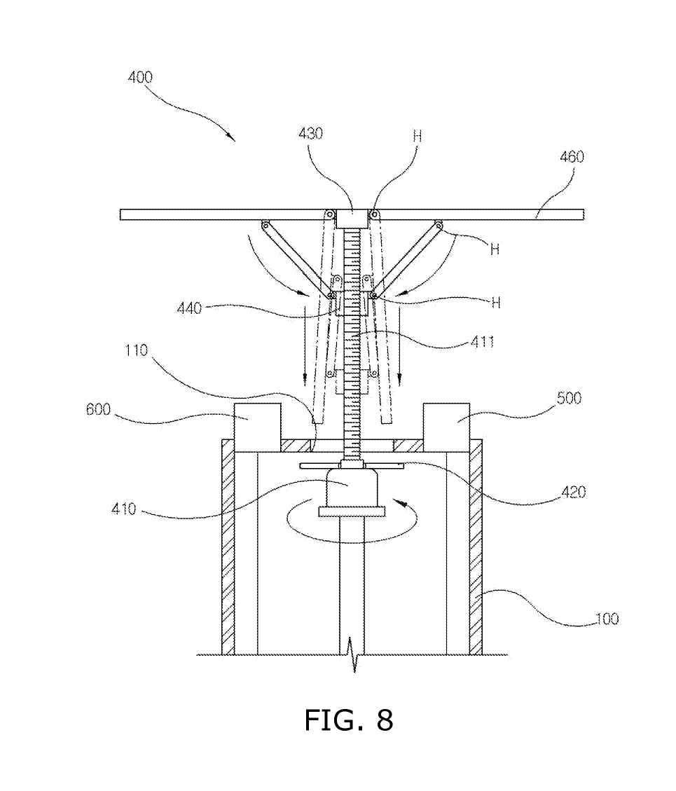

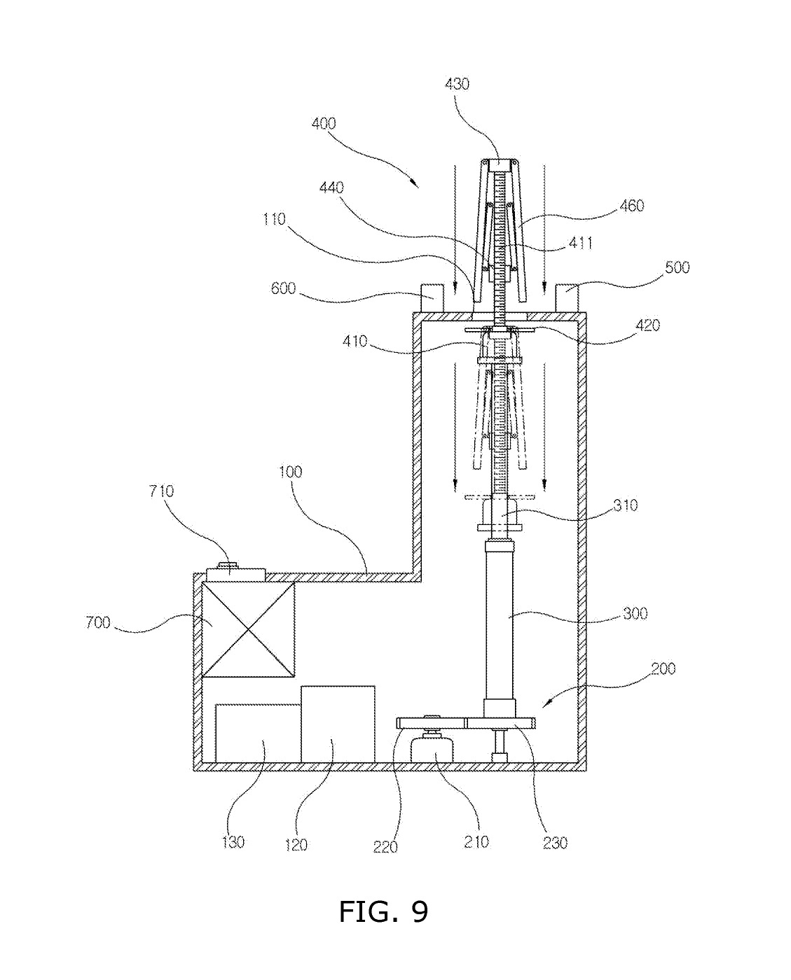

Hereinafter, the operation of the present solar power generation system will be described with reference to FIG. 6 to FIG. 9. FIG. 6 is a perspective view of a state when a power generation assembly of a solar power generation system in accordance with the present disclosure is ascended and unfolded. FIG. 7 is a top view for describing a movement of solar cell plates depending on a sun position for a solar power generation system in accordance with the present disclosure. FIG. 8 is a side elevation view for describing fold and unfold operations of solar cell plates for a solar power generation system in accordance with the present disclosure. FIG. 9 is a side elevation view for describing a descending operation of a power generation assembly of a solar power generation system in accordance with the present disclosure.

First, the operator may power on the solar power generation system using the manual control 710 or the wireless controller 800. Using the manual mode 712, the operator may control the hydraulic or pneumatic cylinder assembly 300 and folding motor 410 such that the power generation assembly 400 is withdrawn from the main body 100 and then the solar cell plates 460 are unfolded, as shown in FIG. 6.

Subsequently, the manual mode 712 may be changed to the automatic mode 711 using the manual control 710 or the wireless controller 800. In the automatic mode, the power generation assembly 400 may generate the electrical energy using the solar cell plates 460 and supply the energy to the storage battery 120. When necessary, the micro-inverter 130 may convert the DC current to the AC current for use.

In the automatic mode, the sun tracking unit 500 may determine the orbital position of the sun based on the variation in the sunshine amount and send the position to the controller 700. Then, the controller 700 may operate the step motor 210 of the rotation assembly 200 based on the received position of the sun to allow the orientation of the solar cell plate 460 of the power generation assembly 400 to be optimally adapted to the sun position. That is, the orientation of the solar cell plate 460 of the power generation assembly 400 may be optimally adapted to the sun position such that the tilted face 461 of thereof may be perpendicular to the sun beam. This may improve the sun beam collection, and, thus, the electrical energy generation.

Further, in the automatic mode, the wind speed sensor 610 may sense the wind speed out of the main body, the shock sensor 620 may sense the shock level applied to the main body 100, and/or the pressure sensor 630 may sense the pressure level applied to the main body 100. Then, the sensed measurements for the speed, the pressure, and the shock may be sent to the controller 700. Then, the controller may compare the measurements for the speed, the pressure, and the shock with the predetermined thresholds for the wind speed, the pressure, and the shock. When the measurements for the speed, the pressure, and the shock exceeds the predetermined thresholds for the wind speed, the pressure, and the shock respectively, the controller 700 may stop the operation of the solar power generation system. That is, the controller 700 may control the folding motor 410 to allow the threaded vertical rod 411 to rotate to allow the hollow nut block 440 to descend to allow the solar cell plates 460 to be folded, as shown in FIG. 8.

Further, when the measurements for the speed, the pressure, and the shock exceeds the predetermined thresholds for the wind speed, the pressure, and the shock respectively, the controller 700 may control the hydraulic or pneumatic cylinder assembly 300 to allow the vertical translation rod 310 to descend to allow the power generation assembly 400 to be retracted into the main body 100. Thus, the power generation assembly 400, particularly, the solar cell plates 460 may be entirely received in the main body 100 and thus may be protected from the strong wind, the shock and the pressure. In one example, the wind speed sensor 610 may sense a strong wind. The shock sensor 620 may sense the hail or heavy rain. The pressure sensor 630 may sense the pressure of the stack of the heavy snow.

While the present solar power generation system accommodates the power generation assembly 400 in the main body 100, the present solar power generation system may be movable.

For the solar power generation system, the manual mode 712 may be available. In this connection, the operator may control manually the system apart from the measurements from the sun tracking unit 500 and sensor set 600. Specifically, the operator may control manually the rotation assembly 200 and the hydraulic or pneumatic cylinder assembly 300 and folding motor 410 to manipulate the power generation assembly 400.

Further, the switching between the automatic mode 711 and manual mode 712 may be performed using the manual control 710 or the wireless controller 800 via the wireless communication module 720.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A solar power generation system comprising:
a main body being hollow and having an inner space defined therein, wherein the main body has a top hole defined in a top wall thereof;
a rotation assembly received in the main body;
a hydraulic or pneumatic cylinder assembly received in the main body;
a power generation assembly configured to be withdrawn from the main body or retracted into the main body through the top hole using the hydraulic or pneumatic cylinder assembly, wherein the power generation assembly has a solar cell structure at a top end thereof, wherein the rotation assembly is configured to change an orientation of the solar cell structure;
a controller configured to control operations of the rotation assembly and the hydraulic or pneumatic cylinder assembly.

2. The system of claim 1, wherein the rotation assembly includes a horizontal-oriented driving gear; a step motor operably coupled to the horizontal-oriented driving gear, wherein the step motor is configured to rotate in a forward and reverse direction; and a horizontal-oriented driven gear meshed with the horizontal-oriented driving gear, wherein the horizontal-oriented driven gear is coupled via a shaft to the solar cell structure, wherein the shaft vertically extend from the horizontal-oriented driven gear through the hydraulic or pneumatic cylinder assembly to the solar cell structure.

3. The system of claim 2, wherein the horizontal-oriented driven gear vertically overlaps the top hole.

4. The system of claim 1, wherein the hydraulic or pneumatic cylinder assembly includes a cylinder body and a vertical translation rod configured to be withdrawn out of or retracted into the cylinder body, wherein the cylinder body has a hydraulic or pneumatic piston vertically moveable therein, wherein the vertical translation rod is fixed to the piston at a top end thereof, wherein the vertical translation rod is coupled to the power generation assembly.

5. The system of claim 1, wherein the power generation assembly includes: a folding motor coupled to the hydraulic or pneumatic cylinder assembly wherein the folding motor operates in a forward and reverse direction.

6. The system of claim 5, wherein the power generation assembly includes: a threaded vertical rod having a thread defined in an outer face thereof, wherein the threaded vertical rod is operably coupled to the folding motor, wherein the threaded vertical rod passes through the top hole defined in the main body.

7. The system of claim 6, wherein the power generation assembly includes a support plate fixed to a top end of the folding motor.

8. The system of claim 6, wherein the power generation assembly includes a hub coupled to the threaded vertical rod at the top end thereof via a bearing such that the rotation of the threaded vertical rod is independent from the rotation of the hub.

9. The system of claim 8, wherein the power generation assembly include a hollow nut block having an inner thread defined in the inner face thereof such that the hollow nut block is engaged with the threaded vertical rod, wherein when the threaded vertical rod rotates, the hollow nut block ascends or descends along the threaded vertical rod along the thread line.

10. The system of claim 9, wherein the power generation assembly includes a vertical translation guide to guide a vertical translation of the hollow nut block, wherein the vertical translation guide extends vertically from a support plate through the hollow nut block to the hub, wherein the support plate is fixed to a top end of the folding motor.

11. The system of claim 10, wherein the solar cell structure includes two solar cell plates radially extending from the hub in a symmetrical manner, wherein each solar cell plate has a tilted face, wherein the tilted faces of the two solar cell plates have the same tilt orientation, wherein each of the two solar cell plates is hinged-coupled to the hub.

12. The system of claim 10, wherein the power generation assembly includes two links to allow an operable connection between the hollow nut block and solar cell plates respectively, wherein each of the links has a lower end hinged-coupled to the hollow nut block via a hinge and an upper end hinged-coupled to the solar cell plate via a hinge.

13. The system of claim 1, further comprising a sun tracking unit configured to measure a sunshine amount depending on a movement of the sun, wherein the sun tracking unit determines an orbital position of the sun based on the variation in the sunshine amount, wherein the sun tracking unit is connected to the controller wirelessly or in a wired manner to send the position of the sun to the controller.

14. The system of claim 13, wherein the controller is configured to control the operation of the rotation assembly based on the position of the sun.

15. The system of claim 1, further comprising a wind speed sensor, a shock sensor and/or a pressure sensor for sensing a speed of a wind out of the main body, a shock and/or a pressure applied to the main body respectively, the wind speed sensor, the shock sensor and/or the pressure sensor are connected to the controller wirelessly or in a wired manner to send the wind speed, the shock and/or pressure to the controller respectively, wherein the controller is configured to operation of the hydraulic or pneumatic cylinder assembly based on the wind speed, the shock and/or pressure.

16. The system of claim 12, further comprising a wind speed sensor, a shock sensor and/or a pressure sensor for sensing a speed of a wind out of the main body, a shock and/or a pressure applied to the main body respectively, the wind speed sensor, the shock sensor and/or the pressure sensor are connected to the controller wirelessly or in a wired manner to send the wind speed, the shock and/or pressure to the controller respectively, wherein the controller is configured to operation of the folding motor based on the wind speed, the shock and/or pressure.

17. The system of claim 15, wherein the controller has a data storage to store a predetermined pressure, shock and/or wind speed, wherein the controller is configured to control the operation of the hydraulic or pneumatic cylinder assembly such that when the wind speed, the shock and/or pressure from the sensors exceed the predetermined pressure, shock and/or wind speed, the power generation assembly is retracted into the main body.

18. The system of claim 16, wherein the controller has a data storage to store a predetermined pressure, shock and/or wind speed, wherein the controller is configured to control the operation of the folding motor such that when the wind speed, the shock and/or pressure from the sensors exceed the predetermined pressure, shock and/or wind speed, the solar cell plates are folded.

19. The system of claim 1, wherein the controller has a mode switching module to allow the solar power generation system to operate in between an automatic mode and manual mode.

20. The system of claim 1, wherein the controller includes a wireless communication module to allow the controller to communicate with a separate wireless controller wirelessly, wherein the wireless controller controls switching between an automatic mode and manual mode of the system.
